(19) United States
(12) Patent Application Publication
(10) Pub. No.: US 2025/0358237 A1
(43) Pub. Date: Nov. 20, 2025

(54) TRANSFER DEVICE, TRANSFER METHOD, AND TRANSFER PROGRAM

(71) Applicant: NIPPON TELEGRAPH AND TELEPHONE CORPORATION, Tokyo (JP)

(72) Inventors: Kanji NAKANO, Tokyo (JP); Takeshi OSAKA, Tokyo (JP); Takamitsu NARUMI, Tokyo (JP); Takayuki NAKAMURA, Tokyo (JP)

(73) Assignee: NIPPON TELEGRAPH AND TELEPHONE CORPORATION, Tokyo (JP)

(21) Appl. No.: 18/872,805

(22) PCT Filed: Jun. 8, 2022
(86) PCT No.: PCT/JP2022/023205

§ 371 Date: Dec. 7, 2024

(51) Int. Cl. H04L 47/6295; H04L 47/625

(52) U.S. Cl. CPC H04L 47/6295; H04L 47/625

(57) ABSTRACT

A transfer device (10) distributes a received packet to each of queues provided in units of logical paths. In addition, the transfer device (10) sets a weight of each of the queues according to an amount of packets in each of the queues provided in units of logical paths, and selects a queue for outputting a packet according to the set weight. Further, the transfer device (10) outputs a packet from the selected queue.

### TECHNICAL FIELD

The present invention relates to a transfer device, a transfer method, and a transfer program.

### BACKGROUND ART

In recent years, in the 5^{th} generation mobile communication system (5G), a network slice that logically divides a network according to network requirements such as a high speed, a large capacity, and a low delay in order to cope with various use cases such as 4K streaming and remote control has become known.

In the network slice, as a technique of assigning an identifier to a header of a packet and performing routing control based on the identifier, there is segment routing (SR) or the like. A transfer device that transfers the network slice can handle a plurality of network slices. The transfer device stores a packet received from an interface in a queue and then outputs the packet.

As a simple queuing method, for example, there is a first-in first-out (FIFO) method in which received packets are sequentially input to one queue and packets are transmitted in order of reception. As a method for solving an increase in queuing delay of FIFO, a method such as controlled delay (CoDel) for increasing a packet discard probability with an increase in queuing delay has been proposed. In addition, there is quality of service (QoS) as a technique for securing a quality of a network.

QoS is a mechanism for performing priority control such that a quality of a service such as that of IP phones does not deteriorate. Differentiated services (DiffServ) using a differentiated services code point (DSCP) value of an IP packet is known as a representative method for guaranteeing QoS. DiffServ is a method that classifies communication flows into several classes, assigns priorities to each class, and performs control. As a QoS technique for securing a quality in units of traffic, a queuing algorithm in which a band is also secured has been proposed. In this technique, a plurality of queues are provided, and a cutting speed is controlled for each of network requirements.

### CITATION LIST

### Non Patent Literature

Non Patent Literature 1: RFC8289 “Controlled Delay Active Queue Management”, [online], [retrieved on Jun. 2, 2022], the Internet <https://www.rfc-editor.org/rfc/pdfrfc/rfc8289.txt.pdf>

### SUMMARY OF INVENTION

### Technical Problem

However, the technique in the related art has a problem that queue management according to network requirements cannot be appropriately performed in some cases. For example, the technique in the related art cannot be applied to a network slice because an option area of an IP packet is used for packet distribution. In addition, in the technique in the related art, there is a problem that a queuing delay may occur in a case where a large number of packets are received in a queue for a low delay, and as a result, network requirements such as 5G cannot be satisfied.

The present invention has been made in view of the above circumstances, and an object of the present invention is to provide a transfer device, a transfer method, and a transfer program capable of appropriately performing queue management according to network requirements.

### Solution to Problem

In order to solve the above-described problems and achieve the object, according to the present invention, there is provided a transfer device including: a distribution unit that distributes a received packet to each of queues provided in units of logical paths; a selection unit that sets a weight of each of the queues according to an amount of packets in each of the queues provided in units of logical paths, and selects a queue for outputting a packet according to the set weight; and an output unit that outputs a packet from the queue selected by the selection unit.

### Advantageous Effects of Invention

According to the present invention, it is possible to appropriately perform queue management according to network requirements.

### BRIEF DESCRIPTION OF DRAWINGS

FIG. 1 is a block diagram illustrating an example of a configuration of a system according to an embodiment.

FIG. 2 is a block diagram illustrating a configuration of a transfer device of the present embodiment.

FIG. 3 is a diagram for explaining queue management by CoDel.

FIG. 4 is a diagram for explaining queue management processing by the transfer device of the present embodiment.

FIG. 5 is a flowchart illustrating an example of a processing procedure by the transfer device of the embodiment.

FIG. 6 is a diagram illustrating a computer that executes a program.

### DESCRIPTION OF EMBODIMENTS

Hereinafter, an embodiment of a transfer device, a transfer method, and a transfer program according to the present application will be described in detail with reference to the drawings. In addition, the present invention is not limited to the embodiment to be described below.

### [Configuration of System]

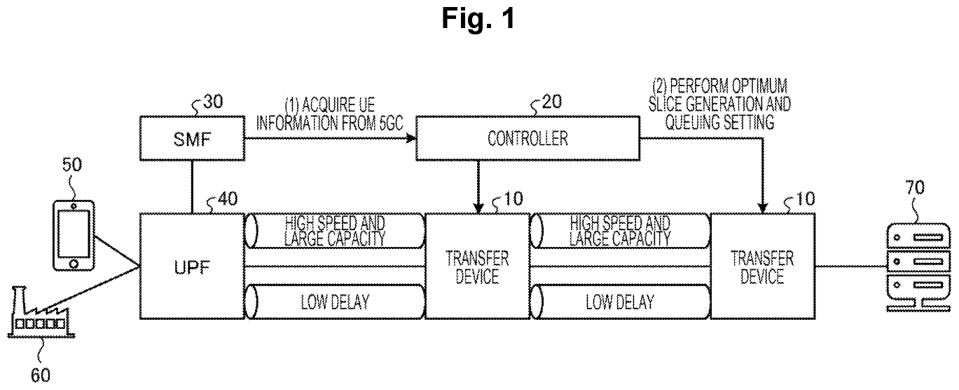

A configuration of a system including a transfer device according to an embodiment will be described. FIG. 1 is a block diagram illustrating an example of a configuration of a system according to the embodiment. As illustrated in FIG. 1, the system includes a plurality of transfer devices 10, a controller 20, a session management function (SMF) 30, a user plane function (UPF) 40, a user terminal 50 such as a smartphone, an IoT device 60 provided in a factory or the like, and a server 70. Note that, in a form of a network illustrated in FIG. 1, each device may perform communication via any communication network such as the Internet, a LAN, or a virtual private network (VPN). In addition, the configuration illustrated in FIG. 1 is merely an example, and a specific configuration and the number of devices are not particularly limited.

The system illustrated in FIG. 1 is, for example, an environment in which there are services in which a network with a high speed and a large capacity is required as a network for 4K videos and the like and services in which a network with a low delay is required for remote control. In addition, a network slice is a network configured by SR, and is configured by a logical path.

The transfer device 10 transfers a packet transmitted and received between the user terminal 50 or the IoT device 60 and the server 70. The transfer device 10 performs, for each network slice, queue management that logically divides a network according to network requirements such as a high speed, a large capacity, or a low delay, and transfers a packet. For example, the transfer device 10 performs queue management in units of logical paths by using a slice identifier such as a segment identifier (SID) of the SR.

The controller 20 performs various controls for each transfer device 10. For example, the controller 20 acquires user equipment (UE) information, QoS information, and the like from the SMF 30, as information required for slice generation and queuing setting. In addition, in a case of performing optimum slice generation for each transfer device 10, the controller 20 performs queuing setting for each slice.

For example, in a case where the network requirement is “low delay” (for example, a delay time is set within a predetermined time), the controller 20 instructs the transfer device 10 to set “CoDel” as an algorithm of the queue, and in a case where the network requirement is “high speed and large capacity”, the controller 20 instructs the transfer device 10 to set “FIFO” because a delay may not be considered.

Further, the controller 20 also changes a queue size according to the network requirements. For example, in a case where the network requirement is “low delay”, the controller 20 instructs the transfer device 10 to set a queue size to be small in order to output packets without a queuing delay, and in a case where the network requirement is “high speed and large capacity”, the controller 20 instructs the transfer device 10 to set a queue size to be large in consideration of a possibility of storing packets having a large data amount.

The SMF 30 has functions such as session management and IP assignment management. For example, the SMF 30 selects a UPF40 to be used in a session. The UPF 40 has a function of user plane processing. The UPF 40 includes a routing/transfer function of data handled in a user plane.

### [Configuration of Transfer Device]

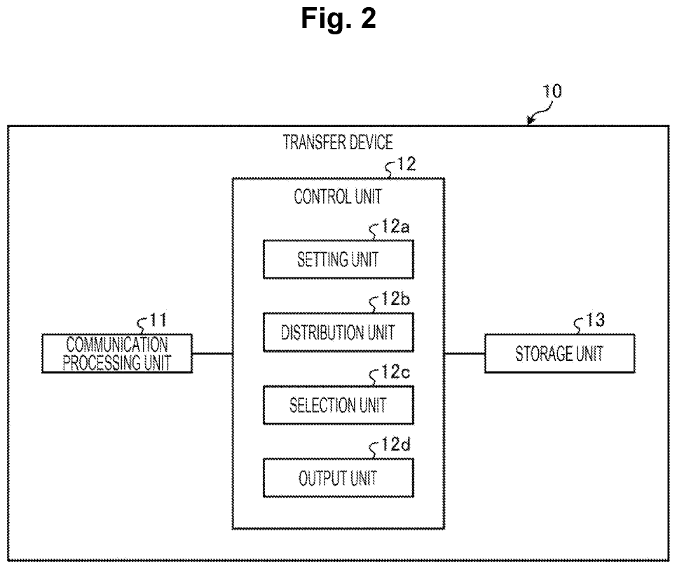

FIG. 2 is a block diagram illustrating a configuration of the transfer device of the present embodiment. As illustrated in FIG. 2, the transfer device 10 of the present embodiment includes a communication processing unit 11, a control unit 12, and a storage unit 13.

The communication processing unit 11 is implemented by a network interface card (NIC) or the like, and controls communication via an electric communication line such as a local area network (LAN) or the Internet.

The storage unit 13 stores data and programs required for various types of processing by the control unit 12. For example, the storage unit 13 is a semiconductor memory element such as a random access memory (RAM) or a flash memory, or a storage device such as a hard disk or an optical disc.

The control unit 12 includes an internal memory for storing a program defining various processing procedures and the like and required data, and executes various types of processing using the program and the data. For example, the control unit 12 includes a setting unit 12a, a distribution unit 12b, a selection unit 12c, and an output unit 12d. Here, the control unit 12 is an electronic circuit such as a central processing unit (CPU) or a micro processing unit (MPU), or an integrated circuit such as an application specific integrated circuit (ASIC) or a field programmable gate array (FPGA).

The setting unit 12a sets an algorithm of each of the queues according to the network requirement of each of the queues. For example, in a case where the network requirement is “low delay”, the setting unit 12a sets “CoDel” as an algorithm of the queue, and in a case where the network requirement is “high speed and large capacity”, the setting unit 12a sets “FIFO” because a delay may not be considered. Therefore, the transfer device 10 can perform appropriate queue management for the network logically divided by the network slice, and can satisfy the network requirement.

Further, the setting unit 12a may set a size of each of the queues according to the network requirement of each of the queues. For example, in a case where the network requirement is “low delay”, the setting unit 12a sets a queue size to be small in order to output packets without a queuing delay, and in a case where the network requirement is “high speed and large capacity”, the setting unit 12a sets a queue size to be large in consideration of a possibility of storing packets having a large data amount. Note that the setting unit 12a may perform these settings at any timing. For example, the setting unit 12a receives the setting instruction from the controller 20, and performs the setting in advance.

The distribution unit 12b distributes the received packet to each of the queues provided in units of logical paths. For example, the distribution unit 12b performs queue management for each logical path by using a value of the SID for packet distribution.

The selection unit 12c sets a weight of each of the queues according to an amount of packets in each of the queues provided in units of logical paths, and selects a queue for outputting a packet according to the set weight. For example, the selection unit 12c adds weight values of queues in which the amount of the packets is equal to or larger than a predetermined threshold value, among queues provided in units of logical paths, compares the weight values of the queues with each other, and selects a queue having the highest weight value as a queue for outputting a packet.

The output unit 12d outputs a packet from the queue selected by the selection unit 12c. In addition, the output unit 12d manages each of the queues by using the queue algorithm which is set by the setting unit 12a. For example, the output unit 12d manages the queues by applying the “CoDel” method to the queue for which the network requirement is “low delay” and applying the “FIFO” method to the queue for which the network requirement is “high speed and large capacity”.

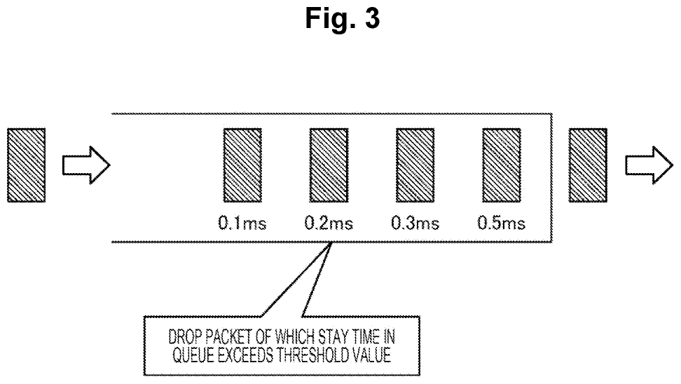

Here, queue management by the CoDel will be described with reference to FIG. 3. FIG. 3 is a diagram for explaining queue management by the CoDel. As illustrated in FIG. 3, in the queue management by the CoDel, in order to solve a queuing delay, on the assumption that a packet is discarded, the transfer device 10 drops (discards) a packet of which the stay time in the queue exceeds a threshold value.

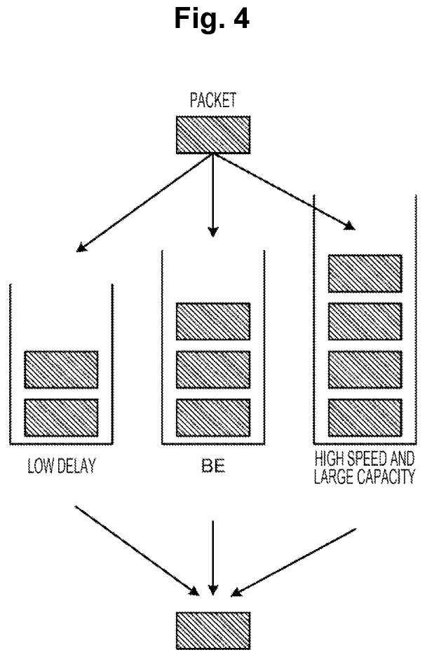

Next, queue management processing by the transfer device 10 will be described with reference to FIG. 4. FIG. 4 is a diagram for explaining queue management processing by the transfer device of the present embodiment. As illustrated in FIG. 4, the transfer device 10 distributes the received packet to any one queue of a queue of which the network requirement is “low delay”, a queue of which the network requirement is “high speed and large capacity”, and a queue of which the network requirement is “best effort”. For the packet distribution, queue management for each logical path is performed by using the value of the SID. For example, the transfer device 10 distributes the received packet to a queue by using the value of the SID.

In addition, the transfer device 10 changes the weight according to the amount of packets in each of the queues, and performs output according to the weight. For example, the transfer device 10 adds weight values of queues in which the amount of the packets is equal to or larger than a predetermined threshold value, among queues provided in units of logical paths, compares the weight values of the queues with each other, selects a queue having the highest weight value as a queue for outputting a packet, and outputs a packet from the selected queue. As described above, the transfer device 10 changes the output interval by changing the weight. Thus, it is possible to output the packets in the queue without causing a queuing delay.

### [Processing Procedure of Transfer Device 10]

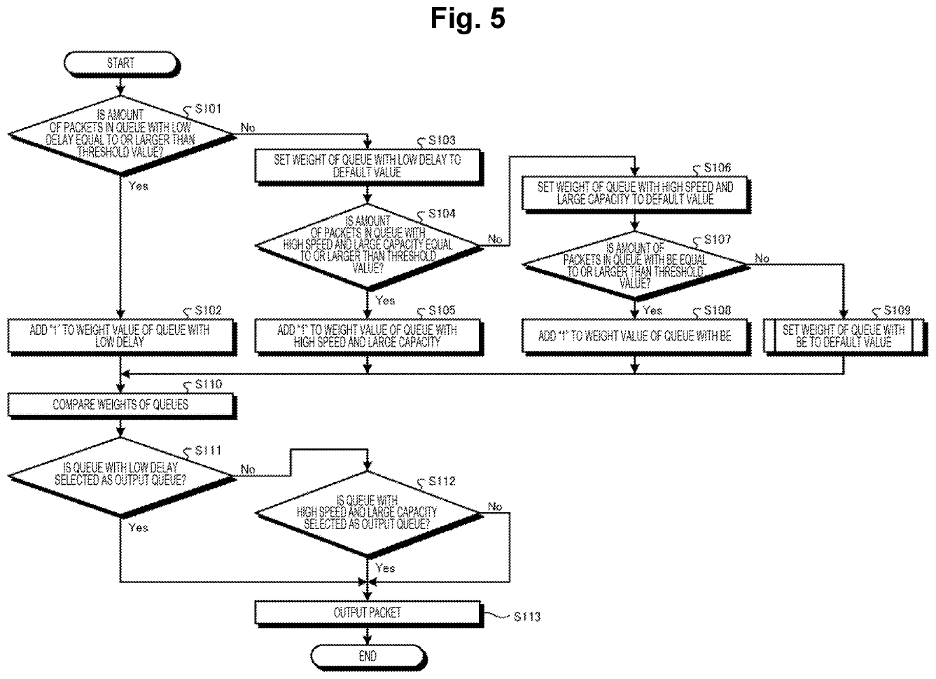

Next, an example of a processing procedure of processing executed by the transfer device 10 will be described with reference to FIG. 5. Note that the transfer device 10 sets, as default weight values, “3” for a queue of which the network requirement is a low delay (described as “queue with low delay” in FIG. 5), “2” for a queue of which the network requirement is “high speed and large capacity” (described as “queue with high speed and large capacity” in FIG. 5), and “1” for a queue of which the network requirement is BE (described as “queue with BE” in FIG. 5). As a method of setting the default weight values, for example, the transfer device 10 sets x=1, calculates the weight value of the queue with a low delay as “x+2”, calculates the weight value of the queue with a high speed and a large capacity as “x+1”, and calculates the weight value of the queue with BE as “x”.

As illustrated in FIG. 5, the selection unit 12c of the transfer device 10 determines whether or not the amount of the packets in the queue with a low delay is equal to or larger than a predetermined threshold value (step S101). As a result, in a case where it is determined that the amount of the packets in the queue with a low delay is equal to or larger than the predetermined threshold value (Yes in step S101), the selection unit 12c adds “1” to the weight value of the queue with a low delay (step S102), and the process proceeds to processing of step S110.

Further, in a case where it is determined that the amount of the packets in the queue with a low delay is smaller than the predetermined threshold value (No in step S101), the selection unit 12c sets the weight of the queue with a low delay to a default value (step S103).

In addition, the selection unit 12c determines whether or not the amount of the packets in the queue with a high speed and a large capacity is equal to or larger than a predetermined threshold value (step S104). As a result, in a case where it is determined that the amount of the packets in the queue with a high speed and a large capacity is equal to or larger than the predetermined threshold value (Yes in step S104), the selection unit 12c adds “1” to the weight value of the queue with a high speed and a large capacity (step S105), and the process proceeds to processing of step S110.

Further, in a case where it is determined that the amount of the packets in the queue with a high speed and a large capacity is smaller than the predetermined threshold value (No in step S104), the selection unit 12c sets the weight of the queue with a high speed and a large capacity to a default value (step S106).

In addition, the selection unit 12c determines whether or not the amount of the packets in the queue with BE is equal to or larger than a predetermined threshold value (step S107). As a result, in a case where it is determined that the amount of the packets in the queue with BE is equal to or larger than the predetermined threshold value (Yes in step S107), the selection unit 12c adds “1” to the weight value of the queue with BE (step S108), and the process proceeds to processing of step S110.

Further, in a case where it is determined that the amount of the packets in the queue with BE is smaller than the predetermined threshold value (No in step S107), the selection unit 12c sets the weight of the queue with BE to a default value (step S109).

In addition, in step S110, the selection unit 12c compares the weights of the queues with each other (step S110). That is, the selection unit 12c selects a queue having the highest weight value as a queue for outputting a packet.

In addition, the output unit 12d determines whether or not the selection unit 12c selects the queue with a low delay as an output queue (step S111). As a result, in a case where the selection unit 12c selects the queue with a low delay as an output queue (Yes in step S111), the output unit 12d outputs a packet from the queue with a low delay (step S113).

Further, in a case where the selection unit 12c does not select the queue with a low delay as the output queue (No in step S111), the output unit 12d determines whether or not the selection unit 12c selects the queue with a high speed and a large capacity as an output queue (step S112). As a result, in a case where the selection unit 12c selects the queue with a high speed and a large capacity as an output queue (Yes in step S112), the output unit 12d outputs a packet from the queue with a high speed and a large capacity (step S113).

Further, in a case where the selection unit 12c does not select the queue with a high speed and a large capacity as an output queue (No in step S112), the output unit 12d outputs a packet from the queue with BE (step S113). Note that, in a case where there is no packet in each of the queues other than the queue with BE, the output unit 12d outputs a packet from the queue with BE.

### Effects of Embodiment

As described above, the transfer device 10 according to the embodiment distributes the received packet to each of the queues provided in units of logical paths. In addition, the transfer device 10 sets a weight of each of the queues according to an amount of packets in each of the queues provided in units of logical paths, and selects a queue for outputting a packet according to the set weight. Further, the transfer device 10 outputs a packet from the selected queue. Therefore, the transfer device 10 can appropriately perform queue management according to the network requirement.

In addition, the transfer device 10 sets an algorithm of each of the queues according to the network requirement of each of the queues. Further, the transfer device 10 sets a size of each of the queues according to the network requirement of each of the queues. Therefore, the transfer device 10 can appropriately perform queue management by applying an algorithm that configures an optimal queue structure in units of applications, and can maximize a network quality for a large capacity and a low delay.

### [System Configuration and the Like]

Each component of each device illustrated according to the embodiment is functionally conceptual, and does not necessarily have to be physically configured as illustrated. That is, a specific form of distribution and integration of devices is not limited to the illustrated form, and all or some of the devices can be functionally or physically distributed and integrated in any unit in accordance with various loads, usage conditions, and the like. Further, all or some of the processing functions performed in each device can be implemented by a CPU and a program analyzed and executed by the CPU or can be implemented as hardware by wired logic.

In addition, among the processing described in the embodiment described above, all or part of the processing described as being automatically performed can be manually performed, or all or part of the processing described as being manually performed can be automatically performed by a known method. Further, the processing procedures, the control procedures, the specific names, and the information including various kinds of data and parameters described in the specification and drawings can be arbitrarily changed, unless otherwise specified.

### [Program]

In addition, it is also possible to create a program in which the processing to be executed by the transfer device described in the embodiment is described in a language that can be executed by a computer. In this case, the computer executes the program, and thus effects similar to those of the embodiment can be obtained. Further, the program may be recorded in a computer-readable recording medium, and the program recorded in the recording medium may be read and executed by the computer. Thereby, processing similar to the processing in the embodiment may be implemented.

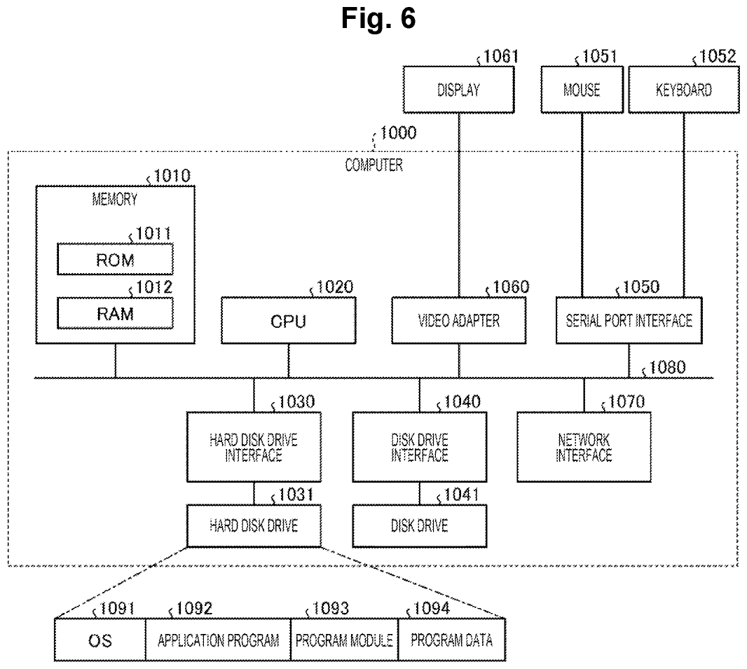

FIG. 6 is a diagram illustrating a computer that executes a program. As illustrated in FIG. 6, a computer 1000 includes, for example, a memory 1010, a CPU 1020, a hard disk drive interface 1030, a disk drive interface 1040, a serial port interface 1050, a video adapter 1060, and a network interface 1070, and these units are connected by a bus 1080.

As illustrated in FIG. 6, the memory 1010 includes a read-only memory (ROM) 1011 and a RAM 1012. The ROM 1011 stores, for example, a boot program such as a basic input output system (BIOS). The hard disk drive interface 1030 is connected to a hard disk drive 1031 as illustrated in FIG. 6. The disk drive interface 1040 is connected to a disk drive 1041 as illustrated in FIG. 6. For example, a removable storage medium such as a magnetic disk or an optical disk is inserted into the disk drive 1041. As illustrated in FIG. 6, the serial port interface 1050 is connected to, for example, a mouse 1051 and a keyboard 1052. As illustrated in FIG. 6, the video adapter 1060 is connected to, for example, a display 1061.

Here, as illustrated in FIG. 6, the hard disk drive 1031 stores, for example, an OS 1091, an application program 1092, a program module 1093, and program data 1094. That is, the program is stored as a program module in which a command to be executed by the computer 1000 is described, for example, in the hard disk drive 1031.

Further, various kinds of data described in the embodiment is stored as program data in, for example, the memory 1010 and the hard disk drive 1031. In addition, the CPU 1020 then reads the program module 1093 and the program data 1094 stored in the memory 1010 and the hard disk drive 1031 into the RAM 1012 as necessary, and executes various processing procedures.

Note that the program module 1093 and the program data 1094 related to the program are not limited to being stored in the hard disk drive 1031, and may be stored in, for example, a removable storage medium and read by the CPU 1020 via the disk drive or the like. Alternatively, the program module 1093 and the program data 1094 related to the program may be stored in another computer connected via a network (such as a local area network (LAN) or a wide area network (WAN)) and read by the CPU 1020 via the network interface 1070.

Although the embodiment to which the invention made by the present inventors is applied has been described above, the present invention is not limited by the description and the drawings which are parts of the disclosure of the present embodiment of the present invention. That is, other embodiments, examples, operational techniques, and the like made by those skilled in the art or the like on the basis of the embodiment are all included in the scope of the present invention.

### REFERENCE SIGNS LIST

10 Transfer device
11 Communication processing unit
12 Control unit
12a Setting unit
12b Distribution unit
12c Selection unit
12d Output unit
13 Storage unit

1. A transfer device comprising:
a distribution device that distributes a received packet to each of queues provided in units of logical paths;
a selection device that sets a weight of each of the queues according to an amount of packets in each of the queues provided in units of logical paths, and selects a queue for outputting a packet according to the set weight; and
an output device that outputs a packet from the queue selected by the selection unit.

2. The transfer device according to claim 1, further comprising:
a setting device that sets an algorithm of each of the queues according to network requirements of each of the queues.

3. The transfer device according to claim 1, wherein the selection device adds weight values of queues in which an amount of packets is equal to or larger than a predetermined threshold value, among the queues provided in logical paths, compares the weight values of the queues with each other, and selects a queue having the highest weight value as the queue for outputting the packet.

4. The transfer device according to claim 2, wherein the setting device sets a size of each of the queues according to network requirements of each of the queues.

5. A transfer method executed by a transfer device, the method comprising:
distributing a received packet to each of queues provided in logical paths;
setting a weight of each of the queues according to an amount of packets in each of the queues provided in logical paths, and selecting a queue for outputting a packet according to the set weight; and
outputting a packet from the queue selected.

6. A computer-readable non-transitory recording medium storing computer-executable program instructions that when executed by a processor cause a computer to execute a transfer process comprising:
distributing a received packet to each of queues provided in logical paths;
setting a weight of each of the queues according to an amount of packets in each of the queues provided in logical paths, and selecting a queue for outputting a packet according to the set weight; and
outputting a packet from the queue selected.

7. The transfer method according to claim 5, further comprising:
setting an algorithm of each of the queues according to network requirements of each of the queues.

8. The transfer method according to claim 5, further comprising:
adding weight values of queues in which an amount of packets is equal to or larger than a predetermined threshold value, among the queues provided in logical paths;
comparing the weight values of the queues with each other; and
selecting a queue having the highest weight value as the queue for outputting the packet.

9. The transfer device according to claim 7, wherein a size of each of the queues is set according to network requirements of each of the queues.

10. The computer-readable non-transitory recording medium according to claim 6 wherein the transfer method further comprising:
setting an algorithm of each of the queues according to network requirements of each of the queues.

11. The computer-readable non-transitory recording medium according to claim 6 wherein the transfer method further comprising:
adding weight values of queues in which an amount of packets is equal to or larger than a predetermined threshold value, among the queues provided in logical paths;
comparing the weight values of the queues with each other; and
selecting a queue having the highest weight value as the queue for outputting the packet.

12. The computer-readable non-transitory recording medium according to claim 10 wherein the transfer method further comprising:
setting a size of each of the queues according to network requirements of each of the queues.
